(19) United States
(12) Patent Application Publication
(10) Pub. No.: US 2022/0362840 A1
(43) Pub. Date: Nov. 17, 2022

(54) MOLD DEGASSING DEVICE

(71) Applicant: AHRESTY CORPORATION, Toyohashi-shi, Aichi (JP)

(72) Inventor: Kosei Saito, Toyohashi-shi, Aichi (JP)

(73) Assignee: AHRESTY CORPORATION, Toyohashi-shi, Aichi (JP)

(21) Appl. No.: 17/766,094

(22) PCT Filed: Oct. 2, 2019
(86) PCT No.: PCT/JP2019/039009

§ 371 Date: Apr. 1, 2022

(51) Int. Cl. B22D 17/22; B22D 17/14

(52) U.S. Cl. CPC B22D 17/22; B22D 17/145

(57) ABSTRACT

A mold degassing device which can reduce the likelihood of particulates entering between a valve stem and an insertion hole is provided. The mold degassing device (10, 40, 50) includes an inflow passage (11, 41, 51), a discharge passage (12), a communication passage (13), a valve device (30) for opening and closing the communication passage (13), a gas-flow adjusting part to adjust a gas flow. A wall surface forming the communication passage (13) is provided with an insertion hole (32d) through which a valve stem (31) of the valve device (30) is inserted. The gas-flow adjusting part is positioned closer to the inflow passage (11, 41, 51) than the insertion hole (32d) and, when gas is discharged, generates a gas flow directed rotationally about an axis (C).

### TECHNICAL FIELD

The present invention relates to a mold degassing device for discharging gas from a cavity in a mold to outside the mold.

### BACKGROUND ART

A mold degassing device has been known in which, when injecting molten metal into a cavity in a mold, gas in the cavity is discharged to outside the mold by sucking the gas via a gas discharge passage using, for example, a vacuum tank and in which, after the cavity is filled with molten metal, the gas discharge passage is closed using a valve device (patent literature 1). The valve device includes a valve body for closing the gas discharge passage by abutting against a valve seat surface formed on a wall surface of the gas discharge passage, a valve stem to an end part of which the valve body is fixed, and a drive unit which is positioned outside the gas discharge passage and moves the valve stem in an axial direction, and the valve stem is inserted through an insertion hole formed through the wall surface of the gas discharge passage.

### CITATION LIST

### Patent Literature

Patent literature 1: Japanese Unexamined Patent Application Publication No. Sho63(1988)-104769

### SUMMARY OF INVENTION

### Technical Problem

According to the existing technology described above, however, there are cases in which, when gas is sucked, solids formed by hardening of splashes of molten metal and particulates of, for example, a mold releasing agent in the cavity enter between the valve stem and the insertion hole. When this occurs, the particulates make it difficult for the valve stem to smoothly slide along the internal peripheral surface of the insertion hole. In such a state, the valve device may fail to appropriately operate and the valve body may become unable to abut against the valve seat surface. Consequently, the molten metal may leak out from the gap between the valve body and the valve seat surface.

The present invention has been made to solve the above problems, and it is an object of the invention to provide a mold degassing device which can reduce the likelihood of particulates entering between a valve stem and an insertion hole.

### Solution to Problems

To achieve the object, a mold degassing device according to the present invention includes an inflow passage leading to a cavity in a mold, a discharge passage for discharging gas to outside the mold, a communication passage through which the inflow passage and the discharge passage are communicated, a valve device for opening and closing the communication passage, and a gas-flow adjusting part for adjusting a gas flow. In the mold degassing device: the valve device includes a valve stem having a first end part and a second end part in an axial direction and being positioned on an axis, a valve body fixed to the first end part, and a drive unit which, holding the second end part of the valve stem, moves the valve body in the axial direction; a wall surface forming the communication passage includes an annular valve seat surface which, by being abutted against by the valve body having moved in the axial direction, closes the communication passage, an inner peripheral wall surface extending from all around the valve seat surface toward the second end part, and an end wall part which closes an end part on a side opposite to the valve seat surface of the inner peripheral wall surface and through which an insertion hole is formed, the insertion hole being for having the valve stem inserted through; a gap is provided all around between the inner peripheral wall surface and an outer peripheral surface of the valve stem; the inner peripheral wall surface is provided with a discharge opening leading to the discharge passage; and the gas-flow adjusting part is positioned closer to the inflow passage than the insertion hole and, when gas is discharged, generates a gas flow directed rotationally about the axis.

### Advantageous Effects of Invention

According to the mold degassing device described in claim 1, an inflow passage leading to a cavity and a discharge passage for discharging gas to outside a mold are communicated through a communication passage. A wall surface forming the communication passage includes an annular valve seat surface against which the valve body of a valve device can abut, an inner peripheral wall surface extending from the valve seat surface toward a second end part of a valve stem with the valve body fixed to a first end part, and an end wall part which closes an end part on a side opposite to the valve seat surface of the inner peripheral wall surface. A gap is provided all around between an outer peripheral surface of the valve stem and the inner peripheral wall surface, and an insertion hole through which the valve stem is inserted is formed through the end wall part. A gas-flow adjusting part positioned closer to the inflow passage than the insertion hole generates, when gas is discharged, a gas flow directed rotationally about the axis, so that, when gas is sucked using, for example, a vacuum tank, a spiral flow about the valve stem is generated on the discharge passage side (the downstream side) of the gas-flow adjusting part. The spiral flow can press particulates having entered the communication passage against the inner peripheral wall surface on the inflow passage side (the upstream side) of the insertion hole, so that the particulates can be discharged from a discharge opening formed through the inner peripheral wall surface to outside the mold via the discharge passage. This can reduce the likelihood of particulates entering between the valve stem and the insertion hole.

According to the mold degassing device described in claim 2, the following effects are achieved in addition to the effects achieved by the mold degassing device described in claim 1. The inflow passage includes an inflow space provided all around the axis and leading to the communication passage on an inside of the valve seat surface and an inflow end part leading to an inflow space via an inflow opening provided on a wall surface forming the inflow space. The gas-flow adjusting part is formed by the inflow space and the inflow end part. Since the inflow opening has an area smaller than an inflow cross-sectional area perpendicular to the axis of the inflow space, the gas-flow adjusting part can generate a gas flow in the inflow space from the gas coming out from the inflow opening. The inflow opening where the gas flow originates is provided away from the axial line, and, from the inflow opening, the inflow end part extends to around the axis. Namely, as viewed in the axial direction, the inflow end part extends not perpendicularly to the axis, so that the gas-flow adjusting part can generate a gas flow directed to rotate about the axis. This allows, when gas is sucked using, for example, a vacuum tank, the gas-flow adjusting part to generate a spiral flow about the valve stem, so that the particulates having entered the communication passage can be pressed against the internal wall surface by the spiral flow. This reduces the likelihood of the particulates entering between the valve stem and the insertion hole.

Furthermore, when gas is sucked, the gas-flow generating part generates a spiral flow in the inflow passage upstream of the valve seat surface, so that, in the vicinity of the insertion hole provided in the communication passage, particulates can be securely pressed against the inner peripheral wall surface. This further reduces the likelihood of particulates entering between the valve stem and the insertion hole.

According to the mold degassing device described in claim 3, the following effects are achieved in addition to the effects achieved by the mold degassing device described in claim 2. A wall surface forming the inflow end part has an inclined surface that inclines toward the second end part in the axial direction as it approaches the inflow opening. This makes it possible to direct the gas flow coming out from the inflow opening also toward the second end part side (the discharge passage side) in the axial direction of the valve stem, so that the stability of the spiral flow generated by the gas-flow adjusting part when gas is sucked can be improved. As a result, the spiral flow can further reduce the likelihood of particulates entering between the valve stem and the insertion hole.

According to the mold degassing device described in claim 4, the following effects are achieved in addition to the effects achieved by the mold degassing device described in any of claims 1 to 3. The distance from the gas flow adjusting part to the discharge opening in the axial direction of the valve stem is longer than a shortest segment cut out by the inner peripheral wall surface from a line perpendicularly crossing the axis. This allows, when gas is sucked, the spiral flow to be adequately stabilized between the gas-flow adjusting part and the discharge opening. As a result, the spiral flow can further reduce the likelihood of particulates entering between the valve stem and the insertion hole.

According to the mold degassing device described in claim 5, the following effects are achieved in addition to the effects achieved by the mold degassing device described in any of claims 1 to 4. The valve device includes a cylindrical guide through which the valve stem is inserted. The outer peripheral surface of the guide and the end part of the guide form a part of an end wall part, and the insertion hole is open through the end part of the guide. The end part of the guide is positioned closer to the first end part than the discharge opening, and a gap is provided all around between the outer peripheral surface of the guide and the inner peripheral wall surface with the gap forming a part of the communication passage. This allows the spiral flow generated in the gas-flow adjusting part when gas is sucked to be stabilized in the vicinity, between the outer peripheral surface of the guide and the inner peripheral wall surface, of the end part of the guide. Furthermore, the distance in the axial direction from the gas-flow adjusting part to the end part of the guide is shorter than a shortest segment cut out by the inner peripheral wall surface from a line perpendicularly crossing the axis. Namely, the end part of the guide where the insertion hole is open can be positioned where the spiral flow generated by the gas-flow adjusting part is adequately strong, so that the likelihood of particulates entering between the insertion hole and the valve stem is further reduced.

According to the mold degassing device described in claim 6, the following effects are achieved in addition to the effects achieved by the mold degassing device described in any of claims 1 to 5. The gas-flow adjusting part is provided with a spiral wall formed spirally about the valve stem to project from one of the valve stem and the inner peripheral wall surface to the other. Therefore, when gas is sucked, the spiral flow about the valve stem can be generated on the discharge passage side of the spiral wall, so that the spiral flow can further reduce the likelihood of particulates entering between the valve stem and the insertion hole.

### BRIEF DESCRIPTION OF DRAWINGS

FIG. 1 is a sectional view of a mold degassing device according to a first embodiment.

FIG. 2 is a sectional view taken along line II-II in FIG. 1 of the mold degassing device.

FIG. 3 is a sectional view taken along line in FIG. 1 of the mold degassing device.

FIG. 4 is a sectional view of a mold degassing device according to a second embodiment.

FIG. 5 is a sectional view taken along line V-V in FIG. 4 of the mold degassing device.

FIG. 6 is a sectional view taken along line VI-VI in FIG. 4 of the mold degassing device.

FIG. 7(a) is a sectional view of a mold degassing device according to a third embodiment, and (b) is a sectional view taken along line VIIb-VIIb in FIG. 7(a) of the mold degassing device.

### DESCRIPTION OF EMBODIMENTS

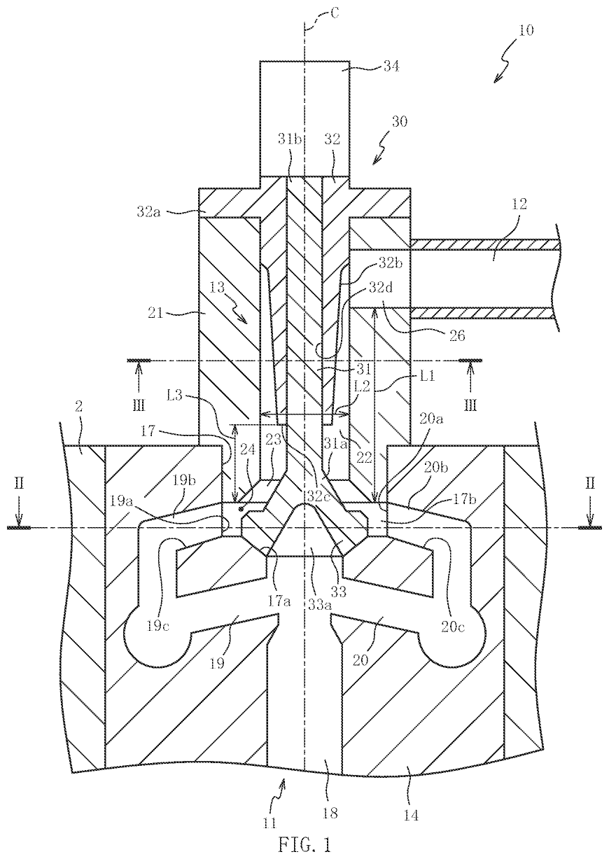

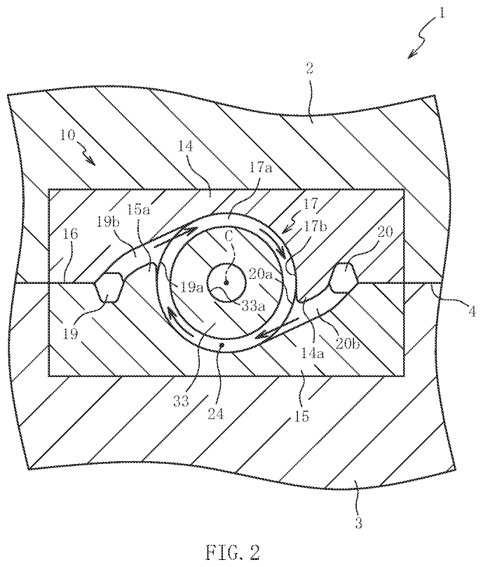

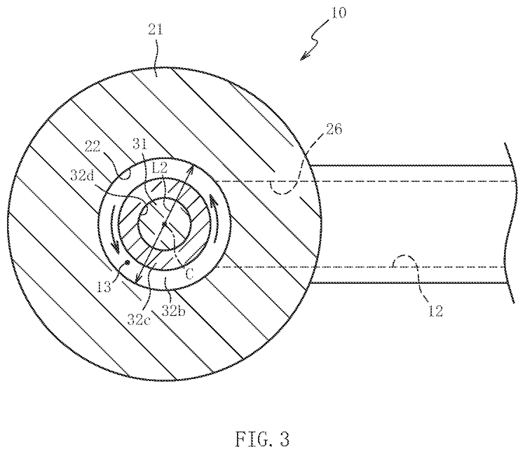

In the following, preferred embodiments of the present invention will be described with reference to the attached drawings. First, with reference to FIGS. 1 to 3, a mold degassing device 10 according to a first embodiment will be described. FIG. 1 is a sectional view of a mold degassing device 10 according to the first embodiment. FIG. 2 is a sectional view taken along line II-II in FIG. 1 of the mold degassing device 10. FIG. 3 is a sectional view taken along line in FIG. 1 of the mold degassing device 10.

As shown in FIG. 1 and FIG. 2, the mold degassing device 10 is for removing gas such as air from a cavity (not shown) in a casting mold 1 and is attached to the mold 1. The mold 1 includes a fixed mold part 2 and a movable mold part 3, with a cavity formed between the fixed mold part 2 and the movable mold part 3. In FIG. 1, a sectional view taken in the vicinity of a dividing face 4 between the fixed mold part 2 and the movable mold part 3 of the mold degassing device 10 is shown. For the convenience of description, parts of the inflow passage 11 (inflow end parts 19b and 20b), positioned, as viewed facing FIG. 1, both on the front side and the back side of the section are schematically shown.

The mold degassing device 10 is provided mainly with an inflow passage 11 leading to the cavity in the mold 1, a discharge passage 12 for discharging gas to outside the mold 1, a communication passage 13 through which the inflow passage 11 and the discharge passage 12 are communicated, and a valve device 30 for opening and closing the communication passage 13. The discharge passage 12 is connected to a vacuum tank (not shown) on the downstream side (on the opposite side to the communication passage 13). When casting is made using the mold 1, gas in the cavity is sucked by the vacuum tank via the inflow passage 11, communication passage 13 and discharge passage 12.

The inflow passage 11 is formed by putting together grooves provided on a first molding part 14 attached to the fixed mold part 2 and a second molding part 15 attached to the movable mold part 3, with the first and second molding parts 14 and 15 forming a dividing face 16 between them. A fixing hole 17 included in the grooves is open in upper end parts of the first molding part 14 and second molding part 15. The fixing hole 17 is circular in section about an axis C and has a bottom face 17a. A part of the bottom face 17a is abutted against by a valve body 33 of the valve device 30.

The inflow passage 11 is provided with a main flow passage 18 opening in the center of the bottom face 17a and extending directly below to reach the cavity, two bypasses 19 and 20 branching from the main flow passage 18 leftward and rightward, respectively, in parallel with the dividing face 16 (leftward and rightward as viewed facing FIG. 1), and an inflow space 24 surrounded by walls formed by an inner peripheral surface 17b and the bottom face 17a of the fixing hole 17. The inflow space 24 is formed all around the axis C.

The bypasses 19 and 20 respectively lead to inflow openings 19a and 20a formed in the inner peripheral surface 17b of the fixing hole 17. Of the bypasses 19 and 20, portions respectively extending outward in the left and right directions from the inflow openings 19a and 20a form the inflow end parts 19b and 20b. The inflow end parts 19b and 20b each have an inflow cross-sectional area approximately uniform over the whole lengths of the inflow end parts 19b and 20b except in the vicinity of the inflow openings 19a and 20a.

The inflow opening 19a is, as shown in FIG. 2 showing a cross-section perpendicular to the axis C as viewed from above, positioned on the left side of the axis C and is open on the inner peripheral surface 17b to be shifted from the dividing face 16 clockwise about the axis C. The inflow end part 19b extends from the inflow opening 19a counterclockwise about the axis C. More specifically, the inflow end part 19b extends from the inflow opening 19a in a tangential direction of the inner peripheral surface 17b.

To form the inflow opening 19a and the inflow end part 19b shaped and positioned as described above, the groove on the dividing face 16 of the first molding part 14 is formed to be deeper toward the inflow opening 19a. A convex part 15a, which is inserted into the groove of the first molding part 14 and whose protrusion increases as it moves toward the inflow opening 19a, protrudes from the dividing face 16 of the second molding part 15.

The inflow opening 20a is, as shown in FIG. 2 showing a cross-section perpendicular to the axis C as viewed from above, positioned on the right side of the axis C and is open on the inner peripheral surface 17b to be shifted from the dividing face 16 clockwise about the axis C. The inflow end part 20b extends from the inflow opening 20a counterclockwise about the axis C. More specifically, the inflow end part 20b extends from the inflow opening 20a in a tangential direction of the inner peripheral surface 17b.

To form the inflow opening 20a and the inflow end part 20b shaped and positioned as described above, the groove on the dividing face 16 of the second molding part 15 is formed to be deeper toward the inflow opening 20a. A convex part 14a, which is inserted into the groove of the second molding part 15 and whose protrusion increases as it moves toward the inflow opening 20a, protrudes from dividing face 16 of the first molding part 14.

The wall surfaces forming the inflow end parts 19b and 20b respectively include inclined surfaces 19c and 20c inclined to be, toward the inflow openings 19a and 20a, closer to the upper side in the axis C direction. The inclined surfaces 19c and 20c make up lower parts in the axis C direction of the wall surfaces forming the inflow end parts 19b and 20b.

As shown in FIG. 1 and FIG. 3, the communication passage 13 is a flow passage formed all around the axis C to extend vertically along the axis C. The communication passage 13 is formed by a cylindrical body 21 with an end part inserted in the fixing hole 17. The wall surface forming the communication passage 13 includes an inner peripheral wall surface 22 which is a part of the inner peripheral surface of the cylindrical body 21 and an annular valve seat surface 23 formed where the corner between the inner peripheral wall surface 22 and the end face of the cylindrical body 21 has been chamfered.

The inner peripheral wall surface 22 is formed to be circular, in a cross-section perpendicular to the axis C, about the axis C and extends upward (toward a second end part 31b of the valve stem 31 being described later) from the whole circumference of the valve seat surface 23. The inner peripheral wall surface 22 has, in an upper circumferential part thereof, a discharge opening 26 leading to the discharge passage 12.

The valve seat surface 23 is a conical surface part tapered to be larger in diameter where farther from the inner peripheral wall surface 22 and is abutted against by the valve body 33 of the valve device 30. In cases where the conical surface part extends more away, beyond its portion abutted against the valve body 33, from the inner peripheral wall surface 22, the portion extending more away from the inner peripheral wall surface 22 forms a part of the wall surface forming the inflow space 24 of the inflow passage 11. Namely, the passage upstream of the valve seat surface 23 forms the inflow passage 11, and the communication passage 13 inside the valve seat surface 23 leads to the inflow space 24 of the inflow passage 11.

As shown in FIG. 1 to FIG. 3, the valve device 30 is for preventing, by closing the communication passage 13 after molten metal is filled in the cavity, the molten metal from leaking out from the mold 1 via the discharge passage 12. The valve device 30 includes a valve stem 31 having a first end part 31a and a second end part 31b in the axis C direction (axial direction) and being positioned over the axis C, a cylindrical guide 32 which is fixed to the cylindrical body 21 and through which the valve stem 31 extends, the valve body 33 fixed to the first end part 31a of the valve stem 31, and a drive unit 34 which holds the second end part 31b of the valve body 33 and moves the valve body 33 in the axis C direction. Note that downward of various parts according to the present embodiment is the first end part 31a side in the axis C direction and that upward of various parts according to the present embodiment is the second end part 31b side in the axis C direction.

The guide 32 is a member partly inserted in the cylindrical body 21 and guides movement in the axis C direction of the valve stem 31. A flange 32a projects radially outward from an upper end part of the guide 32. With the flange 32a fixed at the upper end part of the cylindrical body 21, the end part opposite to the valve seat surface 23 of the inner peripheral wall surface 22 is closed by the guide 32.

The outer peripheral surface 32b and an end part 32c on the first end part 31a side of the guide 32 form an end wall part as a part of the wall surface forming the communication passage 13. The end part 32c is positioned closer to the first end part 31a than the edge closest to the first end part 31a of the discharge opening 26, and an insertion hole 32d where the valve stem 31 is inserted is open in the center of the end part 32c. A gap is provided all around between the outer peripheral surface 32b of the guide 32 and also the outer peripheral surface of the portion projecting from the end part 32c of the valve stem 31 and the inner peripheral wall surface 22, with the gap forming a part of the communication passage 13.

The valve body 33 is for closing the communication passage 13 by abutting on the valve seat surface 23 and projects radially outward from the first end part 31a of the valve stem 31. The valve body 33 is mainly positioned in the inflow space 24, and a gap is provided all around between the valve body 33 and the inner peripheral surface 17b of the fixing hole 17, the gap being a part of the inflow space 24.

A method of casting using the mold degassing device 10 as described above will be described. First, in a state where the valve device 30 has opened the communication passage 13 by pressing the valve body 33 against the bottom face 17a, suction is started by a vacuum tank connected to the discharge passage 12. This causes the gas in the cavity to be discharged to outside the mold 1 passing the main passage 18, the bypasses 19 and 20, the inflow space 24, between the valve seat surface 23 and the valve body 33, between the valve stem 31 and also the guide 32 and the inner peripheral wall surface 22, and the discharge passage 12 in this order.

As molten metal (not shown) is injected into the cavity while gas is sucked, the cavity is filled with the molten metal, then the molten metal starts rising in the inflow passage 11. With a concave 33a formed on the end part facing the main passage 18 of the valve body 33, the rising molten metal hits the concave 33a to apply an upward pressure again the valve body 33. The upward pressure moves the valve body 33 upward against the pressing force applied by the drive unit 34 and forces the valve body 33 to abut against the valve seat surface 23, thereby causing the communication passage 13 to be closed. After hardening of the molten metal, the cylindrical body 21 fixed with the valve device 30 is removed from the fixing hole 17, then the cast item is obtained by separating the fixed mold part 2 and the movable mold part 3.

In the above process, the molten metal is injected into the cavity while gas is sucked, so that, before the valve body 33 abuts against the valve seat surface 23, solids formed by hardening of splashes of the molten metal and particulates of, for example, a mold releasing agent in the cavity also pass through the communication passage 13 and other parts together with gas. Such particulates may enter between the valve stem 31 and the insertion hole 32d to possibly cause the valve device 30 to malfunction.

According to the present embodiment, however, a gas-flow adjusting part is formed by the inflow space 24 and the inflow end parts 19b and 20b, and the gas-flow adjusting part can reduce the likelihood of particulates entering between the valve stem 31 and the insertion hole 32d. Specifically, in the gas-flow adjusting part, the areas of the inflow openings 19a and 20a provided in the boundaries between the inflow end parts 19b and 20b and the inflow space 24 are smaller than the flow-passage cross-sectional area perpendicular to the axis C of the inflow space 24, so that the gas coming out from the inflow opening 19a and 20a can generate gas flows in the inflow space 24.

The inflow openings 19a and 20a where the gas flows originate are provided away from the axis C, and, from the inflow openings 19a and 20a, the inflow end parts 19b and 20b extend to around the axis C. Namely, as viewed in the axis C direction, the inflow end parts 19b and 20b extend not perpendicularly to the axis C, so that the gas-flow adjusting part can generate gas flows directed to rotate about the axis C to inflow space 24 as shown by arrows in FIG. 2. Since the inflow space 24 provided all around the axis C and the communication passage 13 are continuous in the axis C direction, when gas is sucked using the vacuum tank, the rotationally directed gas flows generated by the gas-flow adjusting part become a spiral flow to spiral about the valve stem 31 and the valve body 33 (about the axis C) as shown by arrows in FIGS. 2 and 3.

Since the gas-flow adjusting part to generate a spiral flow on the discharge passage 12 side (on the downstream side) is provided closer to the inflow passage 11 (on the upstream side) than the insertion hole 32d, particulates can be pressed against the portion upstream of the insertion hole 32d of the inner peripheral wall surface 22 by the spiral flow. Then, the particulates in a state of pressed against the inner peripheral wall surface 22 by the spiral flow can be discharged to outside the mold 1 via the discharge opening 26 provided on the surface of the inner peripheral wall surface 22. This reduces the likelihood of the particulates entering between the valve stem 31 and the insertion hole 32d.

Furthermore, the gas-flow adjusting part formed by the inflow space 24 and the inflow end parts 19b and 20b is positioned in the inflow passage 11 upstream of the valve seat surface 23, so that, when gas is sucked, the gas-flow adjusting part can generate a spiral flow in the inflow passage 11. Therefore, the spiral flow stabilizes near the insertion hole 32d formed in the communication passage 13, allowing the spiral flow to securely press particulates against the inner peripheral wall surface 22. This further reduces the likelihood of particulates entering between the valve stem 31 and the insertion hole 32d.

In the inflow space 24, the two inflow end parts 19b and 20b are mutually communicated via the inflow openings 19a and 20a, respectively, and extend from the inflow openings 19a and 20a in a same direction. This allows the gas flows coming from the inflow openings 19a and 20a being rotationally directed to be amplified without canceling each other. In addition, compared with a gas flow coming from an inflow opening of an area larger than the combined area of the inflow openings 19a and 20a, the gas flows coming from the relatively small inflow openings 19a and 20a can be made more forceful. These effects increase the stability of the spiral flow about the valve stem 31 and the valve body 33, so that the likelihood of particulates entering between the valve stem 31 and the insertion hole 32d is further reduced.

The inflow end parts 19b and 20b are each formed to have a flow passage cross-sectional area substantially constant substantially over the whole length, so that the gas flows passing through the inflow end parts 19b and 20b can be stabilized. This makes it easy to stabilize the gas flows generated by the gas entering the inflow space 24 from the inflow openings 19a and 20a via the inflow end parts 19b and 20b and directed to rotate about the axis C, so that stabilizing the spiral flow generated in the inflow passage 11 when gas is sucked is also made easy. Consequently, the likelihood of particulates entering between the valve stem 31 and the insertion hole 32d is further reduced.

The valve seat surface 23 forming a part of the wall surface of the communication passage 13 downstream of the gas-flow adjusting part is smaller in diameter toward the downstream, so that the spiral flow along the valve seat surface 23 can be made more forceful in the downstream. Also, the inner peripheral wall surface 22 is formed to be, in a section thereof including the axis C, substantially parallel with the axis C, so that the spiral flow along the inner peripheral wall surface 22 does not easily weaken.

The inclined surfaces 19c and 20c of the walls forming the inflow end parts 19b and 20b are inclined to be closer, toward the inflow openings 19a and 20a, to the second end part 31b in the axis C direction of the valve stem 31. This makes it possible to direct the gas flows coming from the inflow openings 19a and 20a also toward the second end part 31b side (toward the discharge passage 12 side) in the axis C direction, so that the stability of the spiral flow generated by the gas-flow adjusting part when gas is sucked is improved. As a result, the spiral flow can further reduce the likelihood of particulates entering between the valve stem 31 and the insertion hole 32d.

The distance L1 in the axis C direction between the inflow space 24 included in the gas-flow adjusting part and the discharge opening 26 is longer than the length L2 of a shortest segment cut out by the inner peripheral wall surface 22 from a line perpendicularly crossing the axis C (the inner diameter of the inner peripheral wall surface 22). This allows, when gas is sucked, the spiral flow to be adequately stabilized between the gas-flow adjusting part and the discharge opening 26. As a result, the spiral flow can further reduce the likelihood of particulates entering between the valve stem 31 and the insertion hole 32d.

The end part 32c where the insertion hole 32d is open of the guide 32 is positioned upstream of the discharge opening 26. Between the outer peripheral surface 32b of the guide 32 and the inner peripheral wall surface 22, a gap is provided to be all around them, and the gap forms a part of the communication passage 13. Therefore, the spiral flow generated in the gas-flow adjusting part when gas is sucked ranges not only to upstream but also to downstream of the end part 32c. This stabilizes the spiral flow near the end part 32c of the guide 32.

Furthermore, the distance L3 in the axis C direction between the inflow space 24 included in the gas-flow adjusting part and the end part 32c of the guide 32 is shorter than the length L2 of a shortest segment cut out by the inner peripheral wall surface 22 from a line perpendicularly crossing the axis C. Since the spiral flow generated by the gas-flow adjusting part is stronger where closer to the gas-flow adjusting part, by making the distance L3 shorter than the length L2, the end part 32c where the insertion hole 32d is open can be positioned where the spiral flow is adequately strong. This makes it easy to press particulates against the inner peripheral wall surface 22 around the end part 32c where the insertion hole 32d is open, so that the likelihood of particulates entering between the insertion hole 32d and the valve stem 31 is further reduced.

Furthermore, compared with the upstream side of the end part 32c, the flow-passage cross-sectional area of the communication passage 13 is smaller between the outer peripheral surface 32b of the guide 32 and the inner peripheral wall surface 22 on the downstream side of the end part 32c. This makes it easy to make the spiral flow generated, when gas is sucked, in the gas-flow adjusting part stronger between the outer peripheral surface 32b of the guide 32 and the inner peripheral wall surface 22 compared with the upstream side of the end part 32c. Therefore, stabilization of the spiral flow between the outer peripheral surface 32b and the inner peripheral wall surface 22 is easier when the distance from the end part 32c to the discharge opening 26 in the axis C direction (distance L1−distance L3) is longer, and, when the spiral flow in this part is stabilized, it is also easier to stabilize the spiral flow on the upstream side of the end part 32c. Since the (distance L1−distance L3) is longer than the length L2 of a shortest segment cut out by the inner peripheral wall surface 22 from a line perpendicularly crossing the axis C, the spiral flow generated in the gas-flow adjusting part can be easily stabilized as a whole. This further reduces the likelihood of particulates entering between the insertion hole 32d and the valve stem 31.

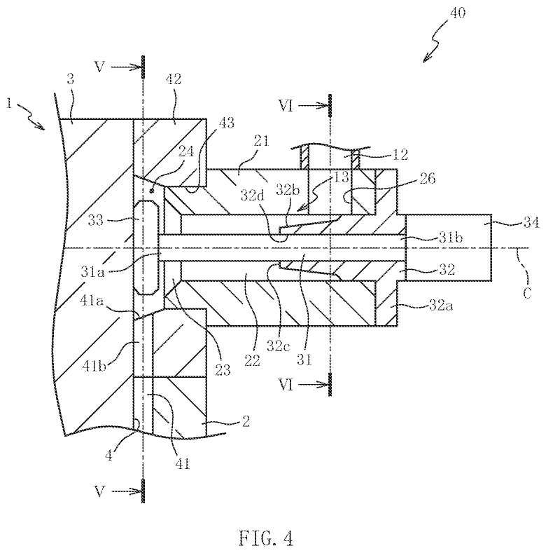

Next, with reference to FIG. 4 to FIG. 6, a second embodiment of the present invention will be described. In the first embodiment described above, a drive unit 34 moves a valve stem 33 up and down to open and close a communication passage 13. In the second embodiment described below, a drive unit 34 moves a valve body 33 left and right to open and close a communication passage 13. In the following, parts identical to those described in connection with the first embodiment will be referred to using the corresponding identical symbols, and their descriptions will be omitted.

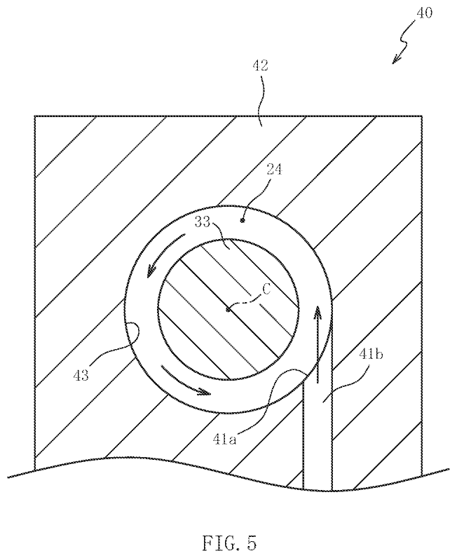

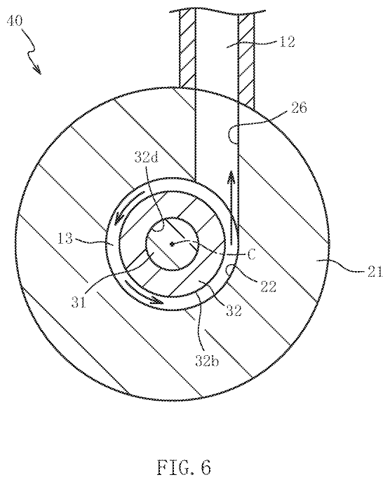

FIG. 4 is a sectional view of a mold degassing device 40 according to the second embodiment. FIG. 5 is a sectional view taken along line V-V in FIG. 4 of the mold degassing device 40. FIG. 6 is a sectional view taken along line VI-VI in FIG. 4 of the mold degassing device 40.

As shown in FIG. 4 and FIG. 5, the mold degassing device 40 is for removing gas such as air from a cavity (not shown) in a casting mold 1 and is attached to the mold 1. In FIG. 4, a sectional view perpendicular to a dividing face 4 between a fixed mold part 2 and a movable mold part 3 is shown with the cross-section including an axis C of a valve stem 31. For the convenience of description, in FIG. 4, a part (an inflow end part 41b) of an inflow passage 41 positioned, as viewed facing FIG. 4, on the front side of the cross-section is schematically shown.

The mold degassing device 40 is provided mainly with the inflow passage 41 leading to the cavity in the mold 1, a discharge passage 12 for discharging gas to outside the mold 1, a communication passage 13 through which the inflow passage 41 and the discharge passage 12 are communicated, and a valve device 30 for opening and closing the communication passage 13. The inflow passage 41 is formed mainly by blocking a groove formed to extend in the vertical direction on a molding part 42 attached to the fixed mold part 2 with the dividing face 4 of the movable mold part 3.

A fixing hole 43 is formed through the molding part 42 perpendicularly to the dividing face 4. The fixing hole 43 has a cross-section circular about the axis C. By blocking one end of the fixing hole 43 with the movable mold part 3 and the other end with a cylindrical body 21, an inflow space 24 surrounded by the inner peripheral surface of the fixing hole 43, the dividing face 4 of the movable mold part 3, and the cylindrical body 21 is formed.

The inflow passage 41 is provided with the inflow space 24 and the inflow end part 41b leading to an inflow opening 41a opening on the wall surface of the inflow space 24. The inflow opening 41a is open on the inner peripheral surface of the fixing hole 43 and is positioned away from the axis C. The inflow end part 41b extends from the inflow opening 41a to around the axis C. To be more specific, the inflow end part 41b extends from the inflow opening 41a in a tangential direction of the inner peripheral wall surface of the fixing hole 43.

A method of casting using the mold degassing device 40 as described above will be described. First, in a state where the valve device 30 has opened the communication passage 13 by pressing the valve body 33 positioned in the inflow space 24 against the movable mold part 3, suction is started by a vacuum tank connected to the discharge passage 12. This causes the gas in the cavity to be discharged to outside the mold 1 passing the inflow passage 41, the inflow space 24, between a valve seat surface 23 and the valve body 33, between the valve stem 31 and also a guide 32 and an inner peripheral wall surface 22, and the discharge passage 12 in this order.

As molten metal is injected into the cavity while gas is sucked, the cavity is filled with the molten metal, then the molten metal starts rising in the inflow passage 41. When the molten metal is detected by a sensor (not shown) provided in the inflow passage 41, the drive unit 34 closes the communication passage 13 by moving the valve body 33 in the axis C direction until the valve body 33 is abutted against the valve seat surface 23. Then, by separating the fixed mold part 2 and the movable mold part 3 after hardening of the molten metal, the cast item is obtained. As in the first embodiment, while gas is sucked before the valve body 33 abuts against the valve seat surface 23, solids formed by hardening of splashes of the molten metal and particulates of, for example, a mold releasing agent in the cavity also pass through the communication passage 13 and other parts.

The area at a boundary between the inflow end part 41b and the inflow space 24 of the inflow opening 41a is smaller than the flow-passage cross-sectional area perpendicular to the axis C of the inflow space 24, so that the gas coming out from the inflow opening 41a can generate a gas flow in the inflow space 24. The inflow opening 41a where the gas flow originates is provided away from the axis C, and, from the inflow opening 41a, the inflow end part 41b extends to around the axis C. Namely, as viewed in the axis C direction, the inflow end part 41b extends not perpendicularly to the axis C, so that a gas-flow adjusting part formed by the inflow space 24 and the inflow end part 41b can generate a gas flow directed to rotate about the axis C as shown by arrows in FIG. 5. Since, when gas is sucked, the gas flow generated by the gas-flow adjusting unit becomes a spiral flow about the valve stem 31 and the valve body 33 as shown by arrows in FIG. 5 and FIG. 6, the likelihood of particulates entering between the valve stem 31 and the insertion hole 32d is reduced.

As shown in FIG. 6, the discharge passage 12 extends from a discharge opening 26 provided on the inner peripheral wall surface 22 to around the axis C (in a circumferential direction of the valve stem 31). This causes, when gas is sucked from the communication passage 13 to the discharge opening 26, a spiral flow about the valve stem 31 is generated in a part near the discharge opening 26 of the communication passage 13. By identically directing the spiral flow generated by the discharge opening 26 and the discharge passage 12 and the spiral flow generated by the inflow space 24 and the inflow end part 41b, the spiral flow generated by the inflow space 24 and the inflow end part 41b can be stabilized until reaching the discharge opening 26. This allows the spiral flow to further reduce the likelihood of particulates entering between the valve stem 31 and the insertion hole 32d.

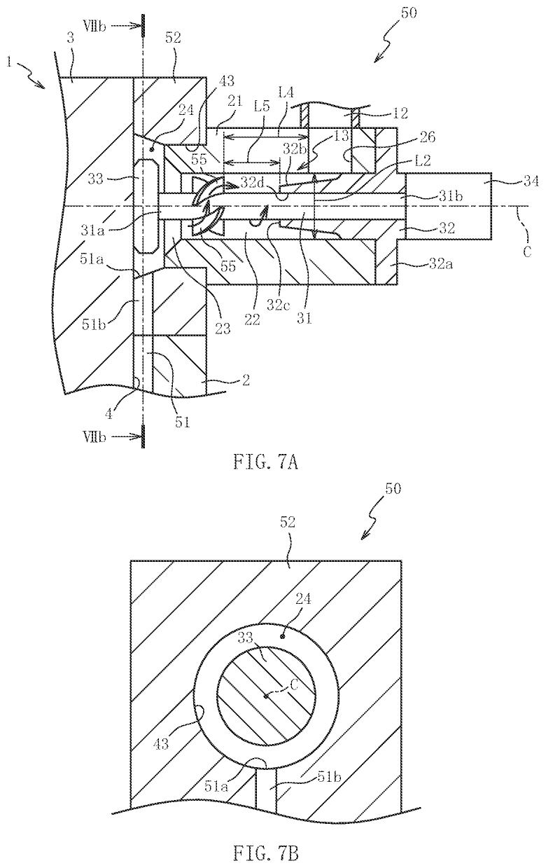

Next, with reference to FIG. 7(a) and FIG. 7(b), a third embodiment of the present invention will be described. In the first and second embodiments described above, a gas-flow adjusting part is formed by an inflow space 24 and inflow end parts 19b, 20b, and 41b. In the third embodiment described below, a gas-flow adjusting part is formed by spiral walls 55. In the following, parts identical to those described in connection with the first and second embodiments will be referred to using the corresponding identical symbols, and their descriptions will be omitted. FIG. 7(a) is a sectional view of a mold degassing device 50 according to the third embodiment. FIG. 7(b) is a sectional view taken along line VIIb-VIIb in FIG. 7(a) of the mold degassing device 50.

As shown in FIG. 7(a) and FIG. 7(b), the mold degassing device 50 is for removing gas such as air from a cavity (not shown) in a casting mold 1 and is attached to the mold 1. In FIG. 7(a), a sectional view perpendicular to a dividing face 4 between a fixed mold part 2 and a movable mold part 3 is shown with the cross-section including an axis C of a valve stem 31.

The mold degassing device 50 is provided mainly with an inflow passage 51 leading to the cavity in the mold 1, a discharge passage 12 for discharging gas to outside the mold 1, a communication passage 13 through which the inflow passage 51 and the discharge passage 12 are communicated, and a valve device 30 for opening and closing the communication passage 13. The inflow passage 51 is formed mainly by blocking a groove formed to extend in the vertical direction on a molding part 52 attached to the fixed mold part 2 with the dividing face 4 of the movable mold part 3. A fixing hole 43 is formed through the molding part 52 perpendicularly to the dividing face 4.

The inflow passage 51 is provided with the inflow space 24 with a part of the wall surface of which formed by the inner peripheral surface of the fixing hole 43 and an inflow end part 51b leading to an inflow opening 51a open on the wall surface of the inflow space 24. The inflow opening 51a is open on the inner peripheral surface of the fixing hole 43 and is positioned away from the axis C. The inflow end part 51b extends from the inflow opening 51a perpendicularly to the axis C. Therefore, in the third embodiment, unlike in the first and second embodiments in which a gas-flow adjusting part is formed by the inflow space 24 and the inflow end parts 19b, 20b, and 41b, the inflow space 24 and the inflow end part 51b generate, when gas is sucked, no spiral flow about the valve stem 31 and the valve body 33.

In the third embodiment, however, the mold degassing device 50 is provided with a gas-flow adjusting part formed by spiral walls 55 provided on the valve stem 31. The spiral walls 55 are each a plate-like member projecting from the valve stem 31 toward an inner peripheral wall surface 22 in a direction perpendicular to the axis C and are each shaped spirally about the valve stem 31. In the present embodiment, four spiral walls 55 are provided rotationally symmetrically about the axis C.

The spiral walls 55 as described above can generate, when gas is discharged, a gas flow in a rotational direction about the valve stem 31 (axis C) on the discharge passage 12 side (on the downstream side). Therefore, when gas is sucked by a vacuum tank, a spiral flow about the valve stem 31 is generated on the downstream side of the spiral walls 55. Since the spiral walls 55 are positioned upstream of an insertion hole 32d, the spiral flow generated by the spiral walls 55 can press particulates against the inner peripheral wall surface 22 on the upstream side of the insertion hole 32d. This consequently reduces the likelihood of particulates entering between the valve stem 31 and the insertion hole 32d.

The distance L4 in the axis C direction from the spiral walls 55 forming the gas-flow adjusting part to a discharge opening 26 is longer than a minimum inner spacing L2 in a direction perpendicular to the axis C of the inner peripheral wall surface 22 (the inner diameter of the inner peripheral wall surface 22). This allows, when gas is sucked, the spiral flow to be adequately stabilized between the spiral walls 55 and the discharge opening 26. As a result, the spiral flow can further reduce the likelihood of particulates entering between the valve stem 31 and the insertion hole 32d.

Furthermore, the distance L5 in the axis C direction from the spiral walls 55 forming the gas-flow adjusting part to an end part 32c of a guide 32 is shorter than the length L2 of a shortest segment cut out by the inner peripheral wall surface 22 from a line perpendicularly crossing the axis C. This allows the end part 32c where the insertion hole 32d is open to be positioned where the spiral flow generated by the gas-flow adjusting part is adequately strong, so that the likelihood of particulates entering between the insertion hole 32d and the valve stem 31 can be further reduced.

The present invention has been described above based on the embodiments, but it is easily understood that the invention is not limited in any way by the above embodiments and that the invention can be modified in various ways without departing from the scope and spirit of the invention. For example, the dimensions and shapes of various parts of the inflow passage 11, discharge passage 12, communication passage 13 and valve device 30 as well as the numbers, positions and shapes of the inflow end parts 19b, 20b 41b and 51b and the spiral walls 55 may be appropriately changed.

By omitting the guide 32, the end part, opposite to the valve seat surface 23, of the inner peripheral wall surface 22 may be blocked with a flat end wall part and the valve stem 31 may be projected into the communication passage 13 from the insertion hole 32d formed through the end wall part. Also, the inflow openings 19a, 20a, and 41a may be provided outside the part to come into contact with the valve body 33 of the bottom face 17a of the fixing hole 17 of the first embodiment or outside the part to come into contact with the valve body 33 of the dividing face 4 of the movable mold part 3 facing the inflow space 24 of the second embodiment.

Even though, according to the third embodiment described above, the spiral walls 55 formed spirally about the valve stem 31 to project from the valve stem 31 toward the inner peripheral wall surface 22, the spiral walls 55 are not limited to be like this. The spiral walls 55 formed spirally about the valve stem 31 may be formed to project from the inner peripheral wall surface 22 toward the valve stem 31. Also, the spiral walls 55 formed spirally about the valve stem 31 to project from either of the valve stem 31 and the inner peripheral wall surface 22 to the other may be applied to a part which, like the drive unit 34 of the first embodiment, opens and closes the communication passage 13 by vertically moving the valve body 33.

Also, an axial flow fan to rotate about the valve stem 31 as an axis may be provided as a gas-flow adjusting part in the communication passage 13. To be specific, the axial flow fan is, for example, one which drives, using a motor, the spiral walls 55 rotationally about the valve stem 31 or causes the spiral walls 55 to be driven about the valve stem 31 when gas is sucked, the spiral walls 55 being formed spirally about the valve stem 31 to project from either of the valve stem 31 and the inner peripheral wall surface 22 to the other.

Both the gas-flow adjusting part formed using the spiral walls 55 and the gas-flow adjusting part formed, as in the first and second embodiments described above, by the inflow space 24 and the inflow end parts 19b, 20b, and 41b may be provided. In this case, by appropriately designing the gas-flow adjusting parts, the spiral flow generated in the gas-flow adjusting part formed by the inflow space 24 and the inflow end parts 19b, 20b, and 41b can be made stronger by the gas-flow adjusting part formed by the spiral walls 55, so that the likelihood of particulates entering between the valve stem 31 and the insertion hole 32d can be further reduced. Depending on the design of each of the gas-flow adjusting parts, the spiral flow formed in the gas-flow adjusting part formed by the inflow space 24 and the inflow end parts 19b, 20b, and 41b is possibly canceled by the gas-flow adjusting part formed by the spiral walls 55. Therefore, avoiding to provide both the gas-flow adjusting part formed by the inflow space 24 and the inflow end parts 19b, 20b, and 41b and the gas-flow adjusting part formed by the spiral walls 55 makes designing a gas-flow adjusting part to form a spiral flow easy.

Even though, according to the first embodiment described above, the inclined surfaces 19c and 20c inclined to be, toward the inflow openings 19a and 20a, closer to the upper side (the second end part 31b side) in the axis C direction are formed on the lower side in the axis C direction of the wall surfaces forming the inflow end parts 19b and 20b, the inclined surfaces 19c and 20c are not limited to be like this. The inclined surfaces 19c and 20c may be provided on the upper side in the axis C direction of the wall surfaces forming the inflow end parts 19b and 20b or on both the upper side and the lower side in the axis C direction.

Even though, according to the embodiments described above, the valve body 33 is positioned upstream of the valve seat surface 23, and the communication passage 13 is closed when the valve body 33 abuts against the valve seat surface 23 tapered to be larger in diameter where farther from the inner peripheral wall surface 22, the communication passage 13 may be closed in a different manner. By positioning the valve body 33 downstream of the valve seat surface 23 and forming the valve seat surface 23 tapered to be smaller in diameter where farther from the inner peripheral wall surface 22, the communication passage 13 may be closed by moving the valve stem 31 making it project more from the insertion hole 32d and abut against the valve seat surface 23. It is, however, preferable to position the valve body 33 upstream of the valve seat surface 23 so as to allow the pressure applied to the valve body 33 by molten metal to firmly press the valve body 33 against the valve seat surface 23.

Even though, according to the first embodiment described above, the inflow passage 11 is formed by the grooves formed on the dividing face 16 of the first molding part 14 attached to the fixed mold part 2 and on the dividing face 16 of the second molding part 15 attached to the movable mold part 3, the inflow passage 11 may be formed differently. By forming the first molding part 14 integrally with the fixed mold part 2 and forming the second molding part 15 integrally with the movable mold part 3, the inflow passage 11 may be formed on the dividing face 4 between the fixed mold part 2 and the movable mold part 3. Similarly, the molding parts 42 and 52 may be formed integrally with the fixed mold part 2. Also, forming the first and second molding parts 14 and 15 and the molding parts 42 and 52 separately from the fixed mold part 2 and the movable mold part 3 makes maintenance and replacement of the inflow passages 11, 41, and 51 easy.

Even though, according to the first embodiment described above, the valve body 33 abuts against the valve seat surface 23 by being pushed up by molten metal, the valve body 33 may be made to operate differently. Like in the second embodiment described above, the drive unit 34 may move, when molten metal is detected by a sensor provided in the inflow passage 11, the valve body 33 in the axis C direction causing the valve body 33 to abut against the valve seat surface 23 and close the communication passage 13.

### DESCRIPTION OF REFERENCE NUMERALS

1: mold
10, 40, 50: mold degassing device
11, 41, 51: inflow passage
12: discharge passage
13: communication passage
19a, 20a, 41a: inflow opening
19b, 20b, 41b: inflow end part (part of gas-flow adjusting part)
19c, 20c: inclined surface
22: inner peripheral wall surface
23: valve seat surface
24: inflow space (part of gas-flow adjusting part)
26: discharge opening
30: valve device
31: valve stem
31a: first end part
31b: second end part
32: guide
32b: outer peripheral surface (part of the end wall part)
32c: end part (part of the end wall part)
32d: insertion hole
33: valve body
34: drive unit
55: spiral wall (gas-flow adjusting part)
C: axis

1. A mold degassing device comprising,
an inflow passage leading to a cavity in a mold,
a discharge passage for discharging gas to outside the mold,
a communication passage through which the inflow passage and the discharge passage are communicated,
a valve device for opening and closing the communication passage, and
a gas-flow adjusting part for adjusting a gas flow,
wherein the valve device includes a valve stem having a first end part and a second end part in an axial direction and being positioned on an axis,
a valve body fixed to the first end part, and
a drive unit which, holding the second end part of the valve stem, moves the valve body in the axial direction,
wherein a wall surface forming the communication passage includes an annular valve seat surface which, by being abutted against by the valve body having moved in the axial direction, closes the communication passage,
an inner peripheral wall surface extending from all around the valve seat surface toward the second end part, and
an end wall part which closes an end part on a side opposite to the valve seat surface of the inner peripheral wall surface and through which an insertion hole is formed, the insertion hole being for having the valve stem inserted through,
wherein a gap is provided all around between the inner peripheral wall surface and an outer peripheral surface of the valve stem,
wherein the inner peripheral wall surface is provided with a discharge opening leading to the discharge passage, and
wherein the gas-flow adjusting part is positioned closer to the inflow passage than the insertion hole and, when gas is discharged, generates a gas flow directed rotationally about the axis.

2. The mold degassing device according to claim 1,
wherein the inflow passage includes an inflow space provided all around the axis and leading to the communication passage on an inside of the valve seat surface and
an inflow end part leading to the inflow space,
wherein a wall surface forming the inflow space has an inflow opening positioned away from the axis,
wherein the inflow end part extends from the inflow opening to around the axis,
wherein the inflow opening has an area smaller than an inflow cross-sectional area perpendicular to the axis of the inflow space, and
wherein the gas-flow adjusting part is formed by the inflow space and the inflow end part.

3. The mold degassing device according to claim 2, wherein a wall surface forming the inflow end part has an inclined surface that inclines toward the second end part in the axial direction as it approaches the inflow opening.

4. The mold degassing device according to claim 1, wherein a distance in the axial direction from the gas flow adjusting part to the discharge opening is longer than a shortest segment cut out by the inner peripheral wall surface from a line perpendicularly crossing the axis.

5. The mold degassing device according to claim 1,
wherein the valve device includes a cylindrical guide through which the valve stem is inserted,
wherein a gap is provided all around between an outer peripheral surface of the guide and the inner peripheral wall surface,
wherein an end part of the guide is positioned closer to the first end part than the discharge opening,
wherein the outer peripheral surface of the guide and the end part form a part of the end wall part and the insertion hole is open in the end part, and
wherein a distance in the axial direction from the gas-flow adjusting part to the end part is shorter than the shortest segment cut out by the inner peripheral wall surface from a line perpendicularly crossing the axis.

6. The mold degassing device according to claim 1, wherein the gas-flow adjusting part is provided with a spiral wall formed spirally about the valve stem to project from one of the valve stem and the inner peripheral wall surface to the other.
